(19) United States
(12) Patent Application Publication
(10) Pub. No.: US 2025/0058525 A1
(43) Pub. Date: Feb. 20, 2025

(54) Print Cartridge and Soot Containments System for Additive Manufacturing

(71) Applicant: Seurat Technologies, Inc., Wilmington, MA (US)

(72) Inventors: Joseph Gillespie, Boxford, MA (US); Erik Raymond Christiansen, Groveland, MA (US); Summer Kapuaimilia Mundon, Medford, MA (US); Theodore A. Parker, Walpole, MA (US); Drew W. Kissinger, Carlisle, MA (US); Andrew J. Bayramian, Marblehead, MA (US)

(21) Appl. No.: 18/806,221

(22) Filed: Aug. 15, 2024

Related U.S. Application Data
(60) Provisional application No. 63/520,176, filed on Aug. 17, 2023.

(51) Int. Cl. B29C 64/35; B22F 12/52; B22F 12/57; B22F 12/60; B22F 12/70; B22F 12/90; B28B 1/00; B29C 64/329; B29C 64/343; B29C 64/393; B33Y 10/00; B33Y 30/00; B33Y 50/02

(52) U.S. Cl. CPC B29C 64/35; B22F 12/57; B22F 12/60; B22F 12/70; B28B 1/001; B29C 64/343; B33Y 10/00; B33Y 30/00; B22F 12/52; B22F 12/90; B29C 64/329; B29C 64/393; B33Y 50/02

(57) ABSTRACT

A cartridge for a manufacturing system includes a sealable chamber having a bed. A powder hopper can be positioned within the sealable chamber. A powder spreader is positioned within the sealable chamber for distributing powder from the powder hopper onto the bed. In some embodiments the powder spreader can include a spreader assembly and a soot confinement enclosure, as wells a dosing mechanism arranged to deposit a specified amount of powder from the powder hopper onto the bed.

### RELATED APPLICATION

The present disclosure is part of a non-provisional patent application claiming the priority benefit of U.S. Patent Application No. 63/520,176, filed on Aug. 17, 2023, which is incorporated by reference in its entirety.

### TECHNICAL FIELD

The present disclosure generally relates to a system and method for high throughput additive manufacturing. In one embodiment powder bed fusion manufacturing is supported by use of discrete print cartridges that support soot confinement mechanisms and methods.

### BACKGROUND

Additive manufacturing systems can require significant time to remove three dimensional (3D) prints, and clean and service the printer before the next 3D print can be started. Even if the 3D print is sealed in a box, the print chamber may still need to be manually cleaned and any wear items (e.g. spreader blades, etc.) manually replaced and re-aligned. Since printing is an inherently dirty process (including production of soot, distribution of unused powder, creation of weld slag, etc.), everything inside the print chamber, for example the spreader blades, gas flow ductwork, glass windows, and spreader drive mechanisms can get covered in dirt. As it is important to assure the purity of the print powder used, it is essential to fully clean out the print chamber and gas duct work before switching materials. Deep cleaning of the print chamber typically involves taking apart many components so that powder and soot can be removed. This work cannot be done through glove ports and can require use of specially trained labor wearing protective gear like respirators.

Another problem results from 3D prints that require an inert gas environment. Whenever a print chamber is opened to atmospheric air it must be evacuated and purged. This process takes a significant amount of time and results in loss of expensive inert gases. These activities lower additive manufacturing throughput since a new 3D print often cannot be started until cleaning and servicing is completed.

Additive manufacturing systems can also require the 3D print to be removed from a controlled printing environment when the 3D print is removed from the print chamber. This can adversely affect 3D prints that require a heat treatment oven for post processing cool down and/or subsequent stress relief, annealing, or other heat treatment. While additive manufacturing systems can pre-heat print plates and/or keep prints at a set temperature during printing in the print chamber, temperature control is often not available outside the print chamber. Unfortunately, when the 3D prints are removed from the print chamber, they are typically not temperature controlled and, in many systems, are also exposed to uncontrolled air. These factors can affect the material properties of the 3D print. Furthermore, 3D prints are often too hot to be immediately removed from the print chamber and so must remain in the print chamber for hours after they are done printing. This ties up the print chamber and prevents the system from starting new print jobs.

### SUMMARY

A cartridge for a manufacturing system includes a sealable chamber having a bed. A powder hopper can be positioned within the sealable chamber. A powder spreader is positioned within the sealable chamber for distributing powder from the powder hopper onto the bed. In some embodiments the powder spreader can include a spreader assembly and a soot confinement enclosure.

In some embodiments, a dosing mechanism can be arranged to deposit a specified amount of powder from the powder hopper onto the bed.

In some embodiments, a dosing mechanism can include a ram located within a first bore. A second bore can be positioned at an inclined angle relative to the first bore, with the second bore open to the powder hopper. A cylindrical valve including a third bore and a fourth bore can be rotatable such that the second and fourth bores align to feed powder to the ram. In some embodiments the cylindrical valve is further rotatable such that the first and third bores align to enable the ram to push powder through the bores to the print bed.

In some embodiments, the cartridge can include an at least one partially detachable lid with one or more laser transparent windows.

In some embodiments, the cartridge can include an at least one partially detachable lid with one or more drive mechanisms for the powder spreader.

In some embodiments, the cartridge can include an at least one partially detachable lid with one or more process monitoring windows.

In some embodiments, the cartridge can include an at least one partially detachable lid with one or more circuits for heating or cooling.

In some embodiments, the cartridge can include an at least one partially detachable lid with one or more sensors for monitoring one or more print processes.

In some embodiments, the cartridge can include an at least one partially detachable lid with sensors able to monitor one or more print processes selected from at least one of print monitoring, thermal monitoring, oxygen monitoring, pressure monitoring, moisture monitoring, powder level monitoring, and print station interface monitoring.

In some embodiments, the cartridge can include an at least one partially detachable lid with one or more connectors for connecting the cartridge to a print station.

In some embodiments, the cartridge can include an at least one partially detachable lid with one or more connectors are selected from one or more connectors for power, water, control signals, and gear coupling for one or more drives.

In some embodiments, the cartridge can include one or more replaceable seals.

In some embodiments, the spreader assembly is adjustable in at least one dimension.

In some embodiments, one or more additional soot management mechanisms can be provided.

In some embodiments, an additional soot management mechanism can include a cross-bed airflow.

an additional soot management mechanism can include a cross-bed airflow with a multi-zone cross bed airflow.

In some embodiments, a method for operating an additive manufacturing system includes providing a sealable chamber having a bed and positioning a powder hopper within the sealable chamber. Powder can be distributed from the powder hopper onto the bed using a powder spreader, with the powder spreader including a spreader assembly and a soot confinement enclosure.

In some method embodiments, deposition a specified amount of powder from the powder hopper onto the bed is ensured by use of dosing mechanism.

In some embodiments, an additive manufacturing system includes a cartridge comprising a sealable chamber having a bed and a powder hopper positioned within the sealable chamber. A powder spreader can be used for distributing powder from the powder hopper onto the bed, with the powder spreader including a spreader assembly and a soot confinement enclosure. A dosing mechanism can be arranged to deposit a specified amount of powder from the powder hopper onto the bed.

In some embodiments, an additive manufacturing system includes a partially detachable lid attached to the sealable chamber and having one or more sensors for monitoring one or more print processes.

### BRIEF DESCRIPTION OF THE DRAWINGS

Non-limiting and non-exhaustive embodiments of the present disclosure are described with reference to the following figures, wherein like reference numerals refer to like parts throughout the various figures unless otherwise specified.

FIG. 1 illustrates a print cartridge for an additive manufacturing system;

FIG. 2 illustrates example connectors on a print cartridge for an additive manufacturing system;

FIG. 3 illustrates an example of a cartridge interior of a print cartridge for an additive manufacturing system;

FIG. 4 illustrates an example of a dosing mechanism for dosing powder in a print cartridge;

FIG. 5 illustrates an example of a partially detachable lid for a print cartridge of an additive manufacturing system;

FIG. 6 is an illustration of an example of a soot confinement enclosure for a print cartridge of an additive manufacturing system.

FIG. 7 illustrates a cartridge based additive manufacturing system able to provide one or two dimensional light beams to a cartridge; and

FIG. 8 illustrates a method of operating a cartridge based additive manufacturing system able to provide one or two dimensional light beams to a cartridge.

### DETAILED DESCRIPTION

In the following description, reference is made to the accompanying drawings that form a part thereof, and in which is shown by way of illustrating specific exemplary embodiments in which the disclosure may be practiced. These embodiments are described in sufficient detail to enable those skilled in the art to practice the concepts disclosed herein, and it is to be understood that modifications to the various disclosed embodiments may be made, and other embodiments may be utilized, without departing from the scope of the present disclosure. The following detailed description is, therefore, not to be taken in a limiting sense.

Described herein is a cartridge for an additive manufacturing system, including a scalable chamber having a bed, a powder hopper positioned within the scalable chamber and a powder spreader for distributing powder from the powder hopper onto the bed. The powder spreader can include a spreader assembly and a soot confinement enclosure. In some examples the spreader assembly and the soot confinement enclosure may be a single assembly. In other examples the spreader assembly and the soot confinement enclosure may be separate assemblies. The spreader assembly can be adjustable in at least one dimension. The spreader assembly can include one or more brushes or blades for distributing powder evenly on the powder bed, for example carbon fiber brushes. In this and other examples, the spreader assembly can include ultrasonic agitation to help facilitate the even spread of powder. The soot confinement enclosure can include an inlet/outlet diffuser. The soot confinement enclosure can include one or more removable panels to facilitate cleaning and maintenance of the soot confinement enclosure.

Using a removable cartridge enables powder operations to be isolated from other operations in an additive manufacturing system, reducing the risk of contamination of optical systems, improving safety for operators by reducing the chances of inhaling potentially harmful soot. The print cartridge facilitates quick changes of material and print cycles. For example, a print station may first be used to complete print operations using steel, Inconel, titanium, aluminum, other metal or alloy. When print operations are completed the cartridge can be rapidly disconnected and removed from the printer and a new cartridge installed. The new cartridge can print using the same or different materials as the prior cartridge, as the powder operations have been isolated and contamination minimized.

The cartridge can further include a dosing device arranged to deposit a specified amount of powder from the powder hopper onto the bed. The dosing mechanism can include a ram located within a first bore, a second bore positioned at an inclined angle relative to the first bore, the second bore connected to the powder hopper and a cylindrical valve comprising a third bore and a fourth bore. The cylindrical valve is rotatable such that the second and fourth bores align to feed powder to the ram. The cylindrical valve can be further rotatable such that the first and third bores align to enable the ram to push powder through the bores to the print bed. The dosing device enables fast and precise dosing of powder to the powder bed.

The cartridge can include an at least partially detachable lid, the at least partially detachable lid comprising one or more laser transparent windows to enable laser light to enter the cartridge from an external print station to fuse powder while isolating sensitive optics from soot and powder contamination. The partially detachable lid can include one or more drive mechanisms for the powder spreader. The partially detachable lid can further include one or more process monitoring windows to enable an operator to monitor print operations either visually be an operator, via one or more video or still cameras or one or more sensors for monitoring the print process. Monitoring the print process can include monitoring at least one of print monitoring, thermal monitoring, oxygen monitoring, pressure monitoring, moisture monitoring, powder level monitoring, and print station interface monitoring. Sensors can also be embedded within the partially detachable lid or withing the cartridge body itself. The partially detachable lid can further include one or more circuits for heating or cooling, for example to enable heating of the printer bed with one or more heating elements located within the cartridge or the partially detachable lid. Cooling can be via water or other coolant circulating within a coolant circuit. The partially detachable lid can further include one or more connectors for connecting the cartridge to a print station, for example connectors for power, water, control signals, and gear coupling for one or more drives. The cartridge can include one or more replaceable seals, for example seals between the cartridge and the partially detachable lid, seals for a gas recirculation system, seals around the print plate (z-axis), seals around viewing windows, and electrical, cooling, or pneumatic feedthroughs. The replaceable seals are used to ensure that the atmosphere in the cartridge is isolated from the ambient atmosphere, and to minimize the escape of powder, dust, soot etc. from the cartridge on to sensitive optical components.

The cartridge can include one or more additional soot management mechanisms, such as, for example, cross-bed airflow with multi-zone cross bed airflow. Soot management mechanisms including soot confinement enclosures and cross-bed airflow can be used to increase efficiency of printing, since soot can impair print efficiency and quality by reducing the amount of laser light reaching the powder bed. Soot can also clog air circulation systems and filters and prove hazardous to human health. By managing soot within the cartridge the print efficiency is increased and system maintenance requirements are reduced.

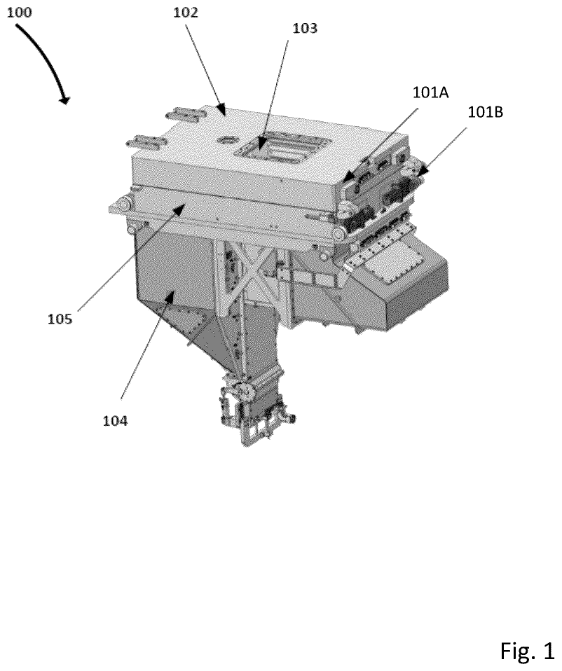

FIG. 1 illustrates an example of a print cartridge 100 for an additive manufacturing system. The 3D print cartridge (hereinafter “cartridge”) separates all of the “dirty” printing functions from the rest of the system and the operator environment and is designed for replacement or removal. “Dirty” printing functions occur wherever powder is present, during processing for printing, or when soot is generated. Whenever the cartridge 100 is connected to mating equipment such as a print station, de-powdering station, or storage station, the mating equipment can supply services required to operate the cartridge as needed based on which station it is mated to. For example, the print station allows full control of the cartridge while the storage station may only provide heating, power, and gas recycling, and use of the camera and/or lights. Services may be supplied via one or more connectors (e.g. connectors 101A or 101B). The one or more connectors may include connectors for power, water, control signals, and gear coupling for one or more drives. The cartridge 100 is designed to be sealed when disconnected from a mating station. In various embodiments connectors can include gas supply ducts for supplying inert gas to the cartridge so that printing can be performed in whatever atmosphere is best for each print. Gas return ducts can remove inert gas.

A partially detachable lid can seal the top of the cartridge 100 against leaks of powder or gas. The partially detachable lid 102 can have one or more laser transparent windows 103 that allow a laser beam (not shown) to pass through it to weld powder. The partially detachable lid 102 allows access to the cartridge for loading print plates, unloading prints, cleaning and servicing the cartridge components (seals, spreader blades etc.) and loading and unloading powder from the powder hopper 104. The partially detachable lid 102 can further include one or more process monitoring windows (not shown).

Diagnostics built into the cartridge can be used to monitor the print process. These built-in diagnostics may include part, powder, and environmental temperatures, image diagnostics at multiple wavelengths, other modalities such as vibrational and ultrasonic imaging and Laser Ultrasonic Imaging System (LUIS) volumetric mapping of printed parts. Diagnostic information can be show on the cartridge or transferred to a remote workstation.

One or more sensors can be embedded within the cartridge body 105 or the partially detachable lid 102 to monitor the print process. The sensors can include cameras, thermal cameras, pyrometers, motion detectors, photodiodes, or other sensors. In some embodiments the sensors may automatically detect events and pan/zoom the camera to focus on the location of interest. In some embodiments, camera images can be viewed by the operator in an electronic or virtual window instead of directly viewing through the process monitoring windows in the partially detachable lid 102 or cartridge body 105.

The cartridge 100 is built around a bed or base plate (not shown in FIG. 1). Fresh powder for a new print is stored in the powder hopper 104 which can have the capacity to store all the powder needed for a full volume print.

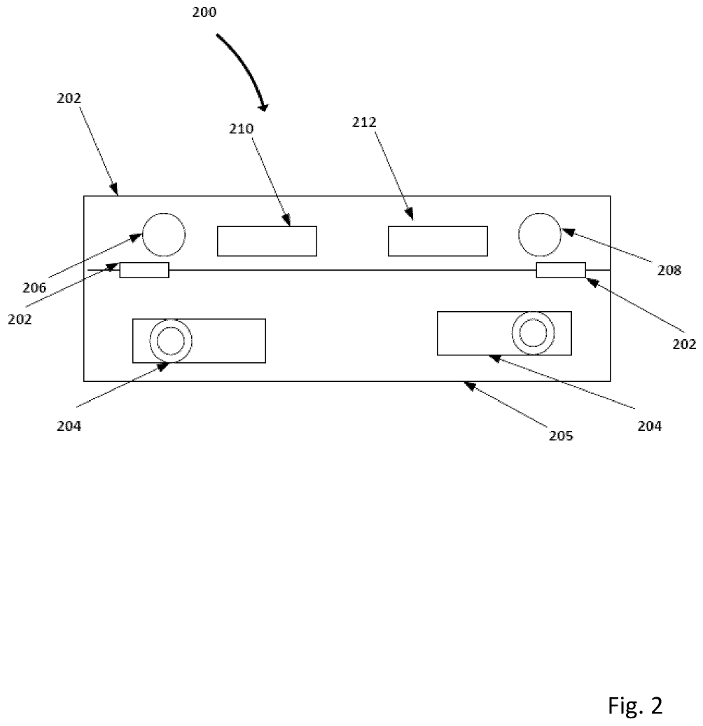

FIG. 2 illustrates example connectors on a print cartridge 200 for an additive manufacturing system. The print cartridge can have an at least partially detachable lid 202, and a cartridge body 205 and connectors can be located on either or both of the at least partially detachable lid 202 and the cartridge body 205. The at least partially detachable lid 202 can be connected to the cartridge body 205 using one or more hinge elements 213.

Drive components (such as motors, actuators, drive belts etc.) can be located in, for example, a print station and employ linkages 206 and 208 to transfer power from the external drive components to driven components inside the cartridge. This reduces the cost and complexity of each cartridge. For instance, a powder spread drive, and/or a soot collection device can be coupled to a linkage structure that is automatically connected when the cartridge is connected into the print station. In various examples the drive components can be connected through one or more of a gearing system, a magneto-restrictive, electrical, magnetic, inductive, hydraulic or other similar types of signal transfer or energy transfer. The cartridge may have one or more connectors to permit gas exchange for supplying an inert atmosphere within the cartridge, for example the cartridge may have a gas inlet and outlet connectors 204

Power coupling through the interface panel can be via an electrical, inductive or optical connector 214 with the latter two allowing for both power and communications to be transferred simultaneously. Additionally, diagnostic information from the various sensors built into the cartridge can occur via electrical, or optical methods. One or more fluid connectors 216 can be used to transfer fluid to or from the cartridge for, for example, cooling the print bed.

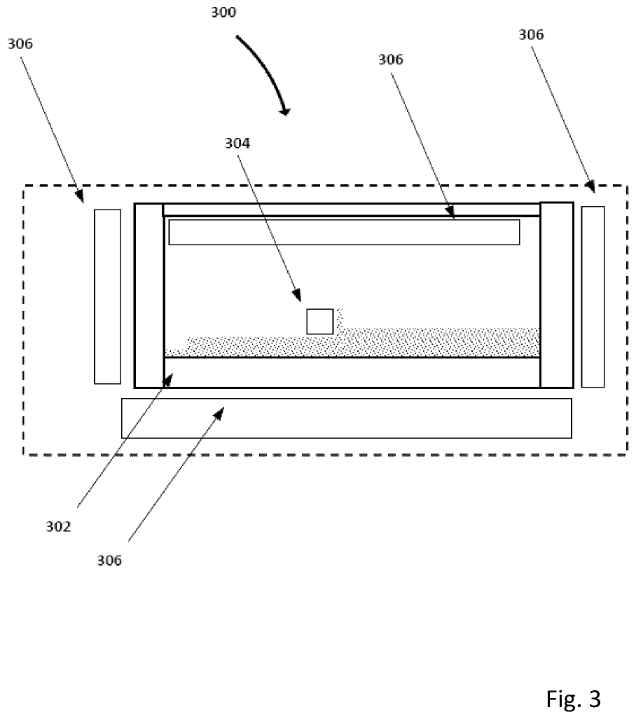

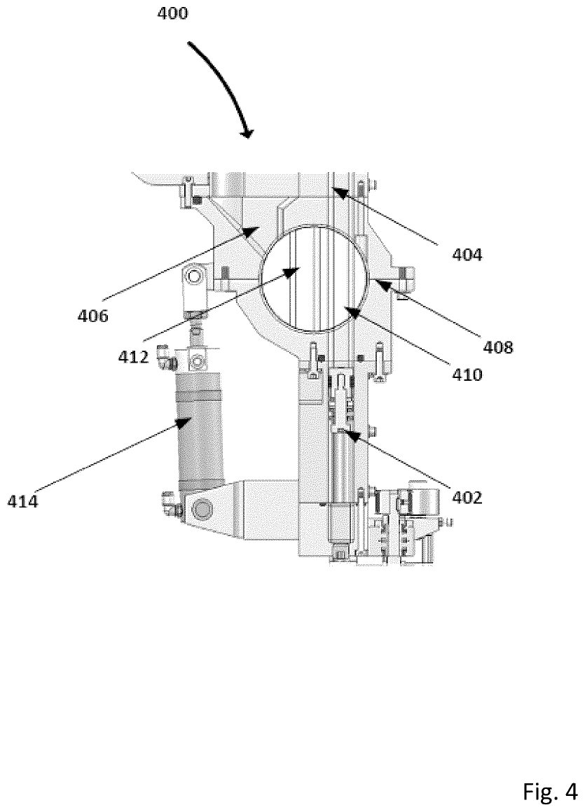

FIG. 3 illustrates an example of a cartridge interior for a print cartridge of an additive manufacturing system. The cartridge 300 is built around a print plate 302 (build or base plate). Fresh powder for a new print is stored in a powder hopper (not shown) which can have the capacity to store all the powder needed for a full volume print. Fresh powder is metered onto the base plate via a dosing mechanism, described in more detail in FIG. 4. Powder is swept across the plate by a powder spreader 304.

The print plate 302 is lowered after each layer is printed so that a new layer of powder can be spread and subsequently printed. The print plate 302 is where layers of powder are melted during printing. In some embodiments the print plate or build plate can be vertically indexed during printing. In various embodiments the print cartridge can incorporate one or more heating or cooling mechanisms for controlling the thermal environment within the print cartridge, for example, heating mechanisms 306 may be built into the cartridge above the print plate, for example, built into the partially detachable lid, or built into one or more sides of the cartridge print volume, the heating mechanisms 306 can also be located below the print plate 310. The total number of heaters can exceed the number of faces of the 3-D print volume in order to allow an operator fine grained control of the environment within the print cartridge. The print volume may further contain one or more cooling mechanisms. The cooling mechanisms may be the same as the heating mechanisms described above or a different mechanism. For example, the cooling mechanism may be a heat exchange mechanism, via water cooling or other fluid coolant circulating. The powder spreader 304 can include a spreader assembly and a soot confinement enclosure. The spreader assembly can be integrated into the partially detachable lid (described with reference to FIG. 1 and FIG. 2). In other embodiments the spreader assembly may be integrated into the cartridge body (such as described with reference to FIG. 1 and FIG. 2).

The spreader assembly can have a spreader brush, for example, a carbon fiber brush arranged to spread dosed powder evenly in an x-y direction. The spreader brush may be mounted via a spreader bridge. In various embodiments the spreader bridge is mounted to linear rails, and a drive mechanism in the partially detachable lid. The spreader bridge may include one or more heating elements and/or cooling elements. The spreader bridge can be further mounted to a base which may include further heating and/or cooling elements. The spreader assembly can include functionality to enable adjustment of the height or level of a spreader brush, for example one or more levelling screws, rocker arms, actuators, levelling rails or combination thereof. The adjustment may be manual or automated. The spreader assembly can further include one or more integrated sensors, for example temperature sensors, optical sensors, IR sensors, gas sensors or other sensors for process monitoring. In an example, temperature sensors and/or pyrometers may be used to monitor the temperature of the spreader bar and/or the temperature of the powder bed. The levelling mechanisms, sensors, and any associated wiring may be enclosed to protect delicate components from powder and soot. In some embodiments the spreader assembly may include ultrasonic excitation to help evenly spread powder. In some embodiments the spreader brush may be a carbon fiber brush. In other embodiments, as an alternative to the spreader brush a metal, ceramic, or carbon fiber blade may be used.

FIG. 4 illustrates an example of a dosing mechanism 400 for dosing powder in a print cartridge. The dosing mechanism is arranged to dose an appropriately metered dose of metal, ceramic or plastic powder or a combination thereof to the cartridge powder bed for additive manufacturing. The dosing mechanism can be included in the cartridge body. The dosing mechanism can include a ram 402 within a first bore 404. The dosing mechanism can further include a second bore 406 positioned at an inclined angle relative to the first bore 406, the second bore 406 open to the powder hopper. The dosing mechanism can also further include a cylindrical valve 408, the cylindrical valve 408 can further include a third bore 410 and a fourth bore 412. In operation the cylindrical valve 408 can be rotated, for example using a drive mechanism 414, to a first position so that the second and fourth bores align to feed powder from the powder hopper to the dosing ram 402. The powder can comprise a metered dose. The powder can be a metal powder, e.g. steel, Inconel, aluminum, titanium, copper, or other metallic elements or combinations thereof, ceramic powder, plastic powder, or combinations of metal, ceramic, or plastic. The cylindrical valve 408 can be further rotated to second position, for example using a drive mechanism, such that the first 404 and third bores align 410 to enable the ram 402 to push powder through the bores to the print bed for accurate dosing of powder to the powder bed.

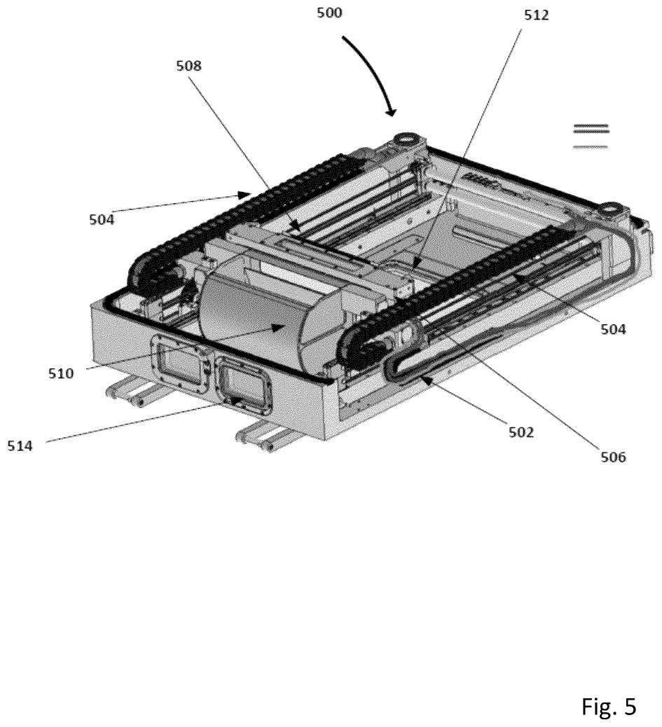

FIG. 5 illustrates an example of a partially detachable lid 500 for a print cartridge of an additive manufacturing system. As described above, the partially detachable lid 500 can have one or more connectors (not shown) for feedthroughs for power, signaling, coolant, engaging drives via gear coupling etc. The partially detachable lid 500 can have one or more hinges (not shown) to allow access to the cartridge print bed. From the connectors one or more feedthroughs can be used to route cables 502 and water lines for signaling, power, cooling etc. The feedthroughs can be hermetically sealed, for example, using one or more replaceable seals. The partially detachable lid may have one or more drive chains 504 to move the powder spreader 506, wherein the powder spreader can include a spreader assembly 508 and the soot confinement enclosure 510, in a horizontal direction. In some embodiments the spreader assembly 508 and the soot confinement enclosure 510 can be moved separately and have separate drive chains. In some embodiments the spreader assembly 508 and the soot confinement enclosure 510 may be coupled with a fixed spacing between them (e.g. 10 mm, 20 mm, 25 mm etc.) or they may be separable. One or either of the spreader assembly 508 and/or the soot confinement enclosure 510 may include a hard stop to prevent damage when the spreader assembly 508 and the soot confinement enclosure 510 butt up against one another.

The partially detachable lid 502 can further include a laser transparent window 512 for passing laser light into the printer cartridge, and one or more process monitoring windows 514 for observing the print status. In some embodiments the one or more process monitoring windows may be replaced by a display screen either connected to the cartridge or remote from the cartridge displaying still or video output received from a camera or other sensors focused on the print bed.

The partially detachable lid may include one or more soot management mechanisms such as soot confinement enclosure 510. In other embodiments the partially detachable lid may include further soot management mechanisms such as mechanisms allowing for cross bed flow. For example, the cross-bed flow can be a flow of gas to entrain print generated soot and remove it from the print chamber. Some examples of cross bed flow mechanisms include air knives, jets near the surface of the print plate, large laminar flow blocks or vortex entrainment. The velocity of the gas and force it imparts on a soot particle keeps the soot particle buoyant until it leaves the bed area. Furthermore, since soot on the laser transparent window can cause a decrease in laser power or print defects due to scattering, cross bed flow can further comprise a cross window flow.

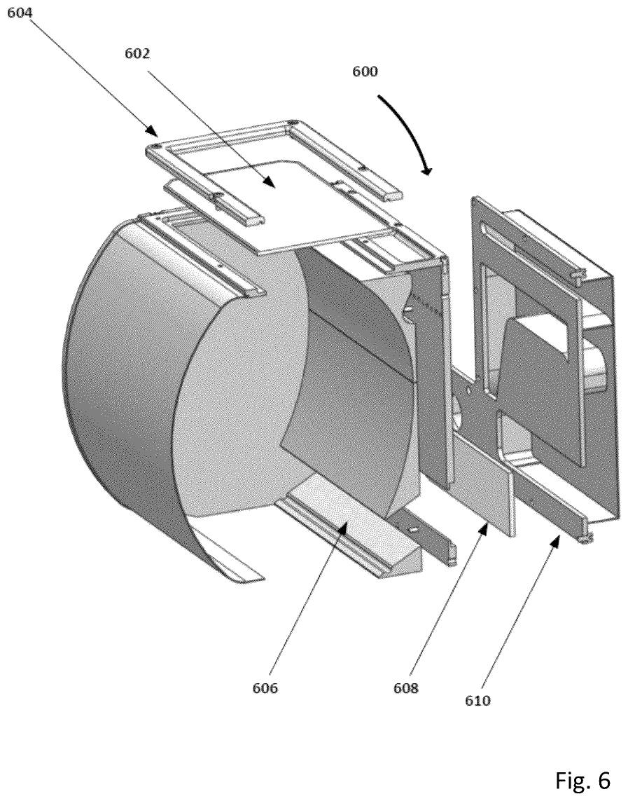

FIG. 6 is an illustration of an example of a soot confinement enclosure 600 for a print cartridge of an additive manufacturing system. The soot confinement enclosure 600 can extract soot reducing maintenance of the gas management system. The soot confinement enclosure can incorporate a laser transparent window 602, allowing laser light to pass through the confinement enclosure and melt powder at the powder bed. In an example, the soot confinement enclosure 600 may be located directly over the area of the powder bed currently being printed. The laser transparent window 602 may be secured to the soot confinement enclosure 600 using a bracket, removable seal, clamp, or other securing means 604. The confinement enclosure reduced the flow of airflow through the soot confinement enclosure to drop soot/powder. The reduction in flow is accomplished is accomplished by increasing the volume of flow area in the soot confinement enclosure with a diffuser on the inlet and outlet. The soot confinement enclosure can have one or more flow modifiers 606, removable side panels to facilitate access to one or more flow modifiers, and/or a diffuser 608. The soot confinement enclosure may be secured to a mounting in removable manner. The flow modifiers reduce the gas velocity and increase uniformity of the flow on entry into the tank to facilitate settling of soot particles. The confinement enclosure is plumbed via an exhaust manifold 610 to extract the soot locally to where the soot is generated. Examples of flow modifiers (or diffusers) are louvers, slits, perforated plates, open cell metal foam. The flow modifiers prevent singular gas jets from crossing the soot confinement enclosure and thereby carrying soot to one or more air filters. Preventing soot from reaching the one or more air filters improves the life of the filter and reduces the required amount of maintenance. Reducing the speed of the gas and lowering its forward velocity increases the residency time in the soot confinement enclosure 600 where gravity has a greater chance to pull particles to the bottom. Countering this is buoyancy induced by the air currents. A lower velocity increases the probability that nano particles collide and agglomerate which makes them fall out of the gas faster. The soot confinement enclosure 600 described herein can catch both large particles of 10 μm or greater but also small particles of less than 10 μm.

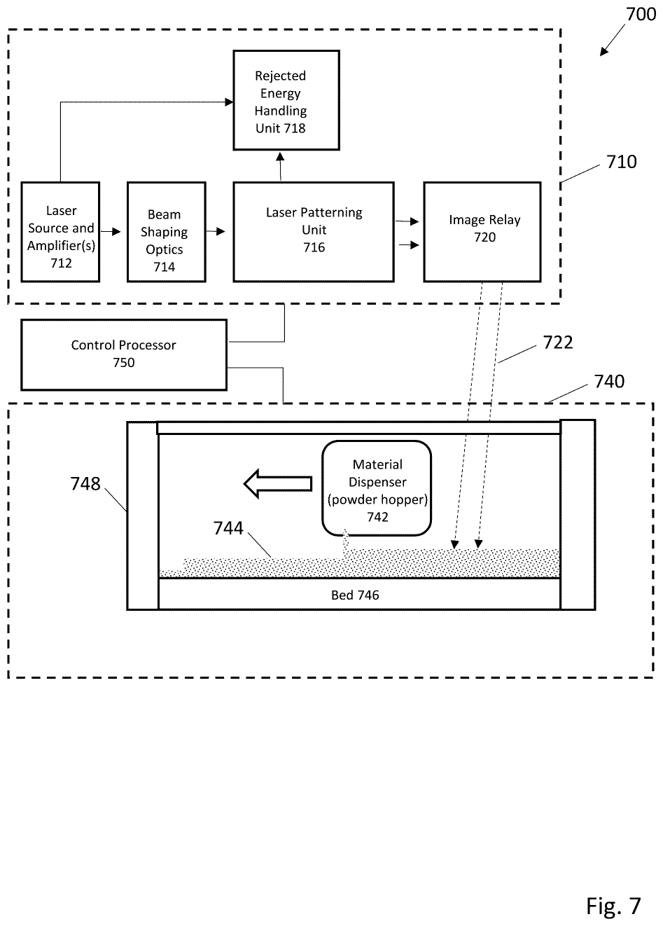

FIG. 7 illustrates operation of an additive manufacturing systems suitable for supporting functionality and components such as previously described with respect to FIGS. 1-6. As seen in FIG. 7, a laser source and amplifier(s) 712 can be constructed as a continuous or pulsed laser. In other embodiments the laser source includes a pulse electrical signal source such as an arbitrary waveform generator or equivalent acting on a continuous-laser-source such as a laser diode. In some embodiments this could also be accomplished via a fiber laser or fiber launched laser source which is then modulated by an acousto-optic or electro optic modulator. In some embodiments a high repetition rate pulsed source which uses a Pockels cell can be used to create an arbitrary length pulse train.

Possible laser types include, but are not limited to: Gas Lasers, Chemical Lasers, Dye Lasers, Metal Vapor Lasers, Solid State Lasers (e.g. fiber), Semiconductor (e.g. diode) Lasers, Free electron laser, Gas dynamic laser, “Nickel-like” Samarium laser, Raman laser, or Nuclear pumped laser.

A Gas Laser can include lasers such as a Helium-neon laser, Argon laser, Krypton laser, Xenon ion laser, Nitrogen laser, Carbon dioxide laser, Carbon monoxide laser or Excimer laser.

A Chemical laser can include lasers such as a Hydrogen fluoride laser, Deuterium fluoride laser, COIL (Chemical oxygen-iodine laser), or Agil (All gas-phase iodine laser).

A Metal Vapor Laser can include lasers such as a Helium-cadmium (HeCd) metal-vapor laser, Helium-mercury (HeHg) metal-vapor laser, Helium-selenium (HeSe) metal-vapor laser, Helium-silver (HeAg) metal-vapor laser, Strontium Vapor Laser, Neon-copper (NeCu) metal-vapor laser, Copper vapor laser, Gold vapor laser, or Manganese (Mn/MnCl2) vapor laser. Rubidium or other alkali metal vapor lasers can also be used. A Solid State Laser can include lasers such as a Ruby laser, Nd:YAG laser, NdCrYAG laser, Er:YAG laser, Neodymium YLF (Nd:YLF) solid-state laser, Neodymium doped Yttrium orthovanadate (Nd:YVO₄) laser, Neodymium doped yttrium calcium oxoborateNd:YCa₄O(BO₃)³ or simply Nd:YCOB, Neodymium glass (Nd:Glass) laser, Titanium sapphire (Ti:sapphire) laser, Thulium YAG (Tm:YAG) laser, Ytterbium YAG (Yb:YAG) laser, Ytterbium:2O₃ (glass or ceramics) laser, Ytterbium doped glass laser (rod, plate/chip, and fiber), Holmium YAG (Ho:YAG) laser, Chromium ZnSe (Cr:ZnSe) laser, Cerium doped lithium strontium (or calcium) aluminum fluoride (Ce:LiSAF, Cc:LiCAF), Promethium 147 doped phosphate glass (147Pm+³:Glass) solid-state laser, Chromium doped chrysoberyl (alexandrite) laser, Erbium doped and erbium-ytterbium co-doped glass lasers, Trivalent uranium doped calcium fluoride (U:CaF₂) solid-state laser, Divalent samarium doped calcium fluoride (Sm:CaF₂) laser, or F-Center laser.

A Semiconductor Laser can include laser medium types such as GaN, InGaN, AlGaInP, AlGaAs, InGaAsP, GaInP, InGaAs, InGaAsO, GaInAsSb, lead salt, Vertical cavity surface emitting laser (VCSEL), Quantum cascade laser, Hybrid silicon laser, or combinations thereof.

As illustrated in FIG. 7, the additive manufacturing system 700 uses lasers able to provide one or two dimensional directed energy as part of an energy patterning system 710. In some embodiments, one dimensional patterning can be directed as linear or curved strips, as rastered lines, as spiral lines, or in any other suitable form. Two dimensional patterning can include separated or overlapping tiles, or images with variations in laser intensity. Two dimensional image patterns having non-square boundaries can be used, overlapping or interpenetrating images can be used, and images can be provided by two or more energy patterning systems. The energy patterning system 710 uses laser source and amplifier(s) 712 to direct one or more continuous or intermittent energy beam(s) toward beam shaping optics 714. After shaping, if necessary, the beam is patterned by an energy patterning unit 716, with generally some energy being directed to a rejected energy handling unit 718. Patterned energy is relayed by image relay 720 toward an article processing unit 740, in one embodiment as a two-dimensional image 722 focused near a bed 746. The article processing unit 740 can include a cartridge such as previously discussed with respect to FIGS. 1-6. The article processing unit 740 has plate or bed 746 (with walls 748) that together form a sealed cartridge chamber containing material 744 (e.g. a metal powder) dispensed by powder hopper or other material dispenser 742. Patterned energy, directed by the image relay 720, can melt, fuse, sinter, amalgamate, change crystal structure, influence stress patterns, or otherwise chemically or physically modify the dispensed and distributed material 744 to form structures with desired properties. A control processor 750 can be connected to variety of sensors, actuators, heating or cooling systems, monitors, and controllers to coordinate operation of the laser source and amplifier(s) 712, beam shaping optics 714, laser patterning unit 716, and image relay 720, as well as any other component of system 700. As will be appreciated, connections can be wired or wireless, continuous or intermittent, and include capability for feedback (for example, thermal heating can be adjusted in response to sensed temperature).

In some embodiments, beam shaping optics 714 can include a great variety of imaging optics to combine, focus, diverge, reflect, refract, homogenize, adjust intensity, adjust frequency, or otherwise shape and direct one or more laser beams received from the laser source and amplifier(s) 712 toward the laser patterning unit 716. In one embodiment, multiple light beams, each having a distinct light wavelength, can be combined using wavelength selective mirrors (e.g. dichroics) or diffractive elements. In other embodiments, multiple beams can be homogenized or combined using multifaceted mirrors, microlenses, and refractive or diffractive optical elements.

Laser patterning unit 716 can include static or dynamic energy patterning elements. For example, laser beams can be blocked by masks with fixed or movable elements. To increase flexibility and ease of image patterning, pixel addressable masking, image generation, or transmission can be used. In some embodiments, the laser patterning unit includes addressable light valves, alone or in conjunction with other patterning mechanisms to provide patterning. The light valves can be transmissive, reflective, or use a combination of transmissive and reflective elements. Patterns can be dynamically modified using electrical or optical addressing. In one embodiment, a transmissive optically addressed light valve acts to rotate polarization of light passing through the valve, with optically addressed pixels forming patterns defined by a light projection source. In another embodiment, a reflective optically addressed light valve includes a write beam for modifying polarization of a read beam. In certain embodiments, non-optically addressed light valves can be used. These can include but are not limited to electrically addressable pixel elements, movable mirror or micro-mirror systems, piezo or micro-actuated optical systems, fixed or movable masks, or shields, or any other conventional system able to provide high intensity light patterning.

Rejected energy handling unit 718 is used to disperse, redirect, or utilize energy not patterned and passed through the image relay 720. In one embodiment, the rejected energy handling unit 718 can include passive or active cooling elements that remove heat from both the laser source and amplifier(s) 712 and the laser patterning unit 716. In other embodiments, the rejected energy handling unit can include a “beam dump” to absorb and convert to heat any beam energy not used in defining the laser pattern. In still other embodiments, rejected laser beam energy can be recycled using beam shaping optics 714. Alternatively, or in addition, rejected beam energy can be directed to the article processing unit 740 for heating or further patterning. In certain embodiments, rejected beam energy can be directed to additional energy patterning systems or article processing units.

In one embodiment, a “switchyard” style optical system can be used. Switchyard systems are suitable for reducing the light wasted in the additive manufacturing system as caused by rejection of unwanted light due to the pattern to be printed. A switchyard involves redirections of a complex pattern from its generation (in this case, a plane whereupon a spatial pattern is imparted to structured or unstructured beam) to its delivery through a series of switch points. Each switch point can optionally modify the spatial profile of the incident beam. The switchyard optical system may be utilized in, for example and not limited to, laser-based additive manufacturing techniques where a mask is applied to the light. Advantageously, in various embodiments in accordance with the present disclosure, the thrown-away energy may be recycled in either a homogenized form or as a patterned light that is used to maintain high power efficiency or high throughput rates. Moreover, the thrown-away energy can be recycled and reused to increase intensity to print more difficult materials.

Image relay 720 can receive a patterned image (either one or two-dimensional) from the laser patterning unit 716 directly or through a switchyard and guide it toward the article processing unit 740. In a manner similar to beam shaping optics 714, the image relay 720 can include optics to combine, focus, diverge, reflect, refract, adjust intensity, adjust frequency, or otherwise shape and direct the patterned light. Patterned light can be directed using movable mirrors, prisms, diffractive optical elements, or solid state optical systems that do not require substantial physical movement. One of a plurality of lens assemblies can be configured to provide the incident light having the magnification ratio, with the lens assemblies both a first set of optical lenses and a second sets of optical lenses, and with the second sets of optical lenses being swappable from the lens assemblies. Rotations of one or more sets of mirrors mounted on compensating gantries and a final mirror mounted on a build platform gantry can be used to direct the incident light from a precursor mirror onto a desired location. Translational movements of compensating gantries and the build platform gantry are also able to ensure that distance of the incident light from the precursor mirror the article processing unit 740 is substantially equivalent to the image distance. In effect, this enables a quick change in the optical beam delivery size and intensity across locations of a build area for different materials while ensuring high availability of the system.

The material dispenser 742 (e.g. powder hopper) in article processing unit 740 (e.g. cartridge) can distribute, remove, mix, provide gradations or changes in material type or particle size, or adjust layer thickness of material. The material can include metal, ceramic, glass, polymeric powders, other melt-able material capable of undergoing a thermally induced phase change from solid to liquid and back again, or combinations thereof. The material can further include composites of melt-able material and non-melt-able material where either or both components can be selectively targeted by the imaging relay system to melt the component that is melt-able, while either leaving along the non-melt-able material or causing it to undergo a vaporizing/destroying/combusting or otherwise destructive process. In certain embodiments, slurries, sprays, coatings, wires, strips, or sheets of materials can be used. Unwanted material can be removed for disposable or recycling by use of blowers, vacuum systems, sweeping, vibrating, shaking, tipping, or inversion of the bed 746.

In addition to material handling components, the article processing unit 740 can include components for holding and supporting 3D structures, mechanisms for heating or cooling the chamber, auxiliary or supporting optics, and sensors and control mechanisms for monitoring or adjusting material or environmental conditions. The article processing unit can, in whole or in part, support a vacuum or inert gas atmosphere to reduce unwanted chemical interactions as well as to mitigate the risks of fire or explosion (especially with reactive metals). In some embodiments, various pure or mixtures of other atmospheres can be used, including those containing Ar, He, Ne, Kr, Xe, CO₂, N₂, O₂, SF₆, CH₄, CO, N₂O, C₂H₂, C₂H₄, C₂H₆, C₃H₆, C₃H₈, i-C₄H1₀, C₄H₁₀, 1-C₄H₈, cic-2, C₄H₇, 1,3-C₄H₆, 1,2-C₄H₆, C₅H₁₂, n-C₅H₁₂, i-C₅H₁₂, n-C₆H₁₄, C₂H₃Cl, C₇H₁₆, C₈H₁₈, C₁₀H₂₂, C₁₁H₂₄, C₁₂H₂₆, C₁₃H₂₈, C₁₄H₃₀, C₁₅H₃₂, C₁₆H₃₄, C₆H₆, C₆H₅—CH₃, C₈H₁₀, C₂H₅OH, CH₃OH, iC₄H₈. In some embodiments, refrigerants or large inert molecules (including but not limited to sulfur hexafluoride) can be used. An enclosure atmospheric composition to have at least about 1% He by volume (or number density), along with selected percentages of inert/non-reactive gases can be used.

In certain embodiments, a plurality of article processing units, cartridges, or build chambers, each having a build platform to hold a powder bed, can be used in conjunction with multiple optical-mechanical assemblies arranged to receive and direct the one or more incident energy beams into the cartridges. Multiple cartridges allow for concurrent printing of one or more print jobs.

In another embodiment, one or more article processing units, cartridges, or build chambers can have a cartridge that is maintained at a fixed height, while optics are vertically movable. A distance between final optics of a lens assembly and a top surface of powder bed a may be managed to be essentially constant by indexing final optics upwards, by a distance equivalent to a thickness of a powder layer, while keeping the build platform at a fixed height. Advantageously, as compared to a vertically moving the build platform, large and heavy objects can be more easily manufactured, since precise micron scale movements of the ever changing mass of the build platform are not needed. Typically, build chambers intended for metal powders with a volume more than ˜0.1-0.2 cubic meters (i.e., greater than 100-200 liters or heavier than 500-1,000 kg) will most benefit from keeping the build platform at a fixed height.

In one embodiment, a portion of the layer of the powder bed in a cartridge may be selectively melted or fused to form one or more temporary walls out of the fused portion of the layer of the powder bed to contain another portion of the layer of the powder bed on the build platform. In selected embodiments, a fluid passageway can be formed in the one or more first walls to enable improved thermal management.

In some embodiments, the additive manufacturing system can include article processing units or cartridges that supports a powder bed capable of tilting, inverting, and shaking to separate the powder bed substantially from the build platform in a hopper. The powdered material forming the powder bed may be collected in a hopper for reuse in later print jobs. The powder collecting process may be automated and vacuuming or gas jet systems also used to aid powder dislodgement and removal.

Some embodiments, the additive manufacturing system can be configured to easily handle parts longer than an available build chamber or cartridge. A continuous (long) part can be sequentially advanced in a longitudinal direction from a first zone to a second zone. In the first zone, selected granules of a granular material can be amalgamated. In the second zone, unamalgamated granules of the granular material can be removed. The first portion of the continuous part can be advanced from the second zone to a third zone, while a last portion of the continuous part is formed within the first zone and the first portion is maintained in the same position in the lateral and transverse directions that the first portion occupied within the first zone and the second zone. In effect, additive manufacture and clean-up (e.g., separation and/or reclamation of unused or unamalgamated granular material) may be performed in parallel (i.e., at the same time) at different locations or zones on a part conveyor, with no need to stop for removal of granular material and/or parts.

In another embodiment, additive manufacturing capability can be improved by use of an enclosure restricting an exchange of gaseous matter between an interior of the enclosure and an exterior of the enclosure. An airlock provides an interface between the interior and the exterior; with the interior having multiple additive manufacturing chambers, including those supporting power bed fusion. A gas management system maintains gaseous oxygen within the interior at or below a limiting oxygen concentration, increasing flexibility in types of powder and processing that can be used in the system.

In another manufacturing embodiment, capability can be improved by having a article processing units, cartridges, or build chamber contained within an enclosure, the build chamber being able to create a part having a weight greater than or equal to 2,000 kilograms. A gas management system may maintain gaseous oxygen within the enclosure at concentrations below the atmospheric level. In some embodiments, a wheeled vehicle may transport the part from inside the enclosure, through an airlock, since the airlock operates to buffer between a gaseous environment within the enclosure and a gaseous environment outside the enclosure, and to a location exterior to both the enclosure and the airlock.

Other manufacturing embodiments involve collecting powder samples in real-time from the powder bed. An ingester system is used for in-process collection and characterizations of powder samples. The collection may be performed periodically and the results of characterizations result in adjustments to the powder bed fusion process. The ingester system can optionally be used for one or more of audit, process adjustments, or actions such as modifying printer parameters or verifying proper use of licensed powder materials.

Yet another improvement to an additive manufacturing process can be provided by use of a manipulator device such as a crane, lifting gantry, robot arm, or similar that allows for the manipulation of parts that would be difficult or impossible for a human to move is described. The manipulator device can grasp various permanent or temporary additively manufactured manipulation points on a part to enable repositioning or maneuvering of the part.

Control processor 750 can be connected to control any components of additive manufacturing system 700 described herein, including lasers, laser amplifiers, optics, heat control, build chambers, and manipulator devices. The control processor 750 can be connected to variety of sensors, actuators, heating or cooling systems, monitors, and controllers to coordinate operation. A wide range of sensors, including imagers, light intensity monitors, thermal, pressure, or gas sensors can be used to provide information used in control or monitoring. The control processor can be a single central controller, or alternatively, can include one or more independent control systems. The controller processor 750 is provided with an interface to allow input of manufacturing instructions. Use of a wide range of sensors allows various feedback control mechanisms that improve quality, manufacturing throughput, and energy efficiency.

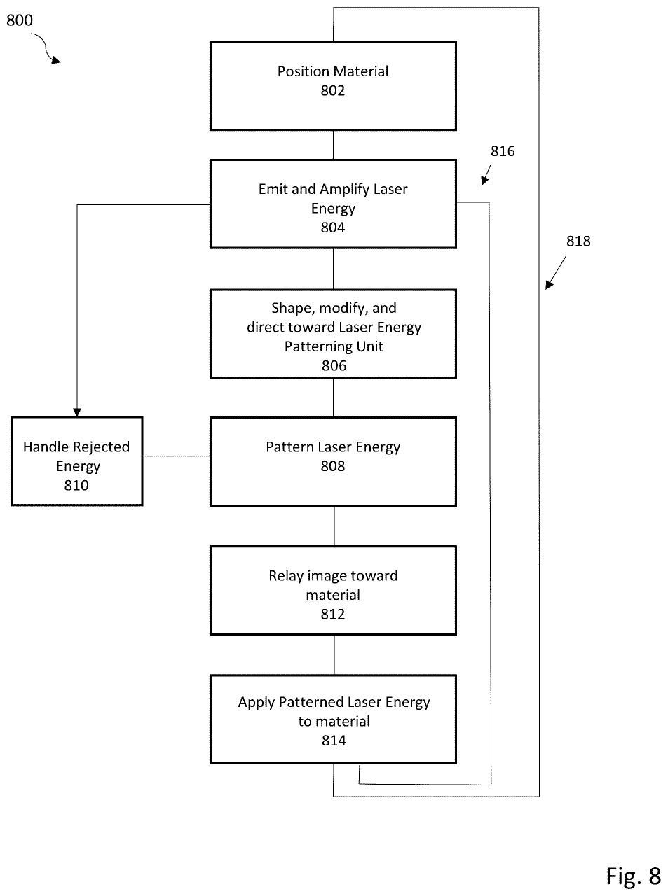

One embodiment of operation of a manufacturing system suitable for additive or subtractive manufacture and suitable for supporting functionality and components such as previously described with respect to FIGS. 1-6 is illustrated in FIG. 8. In this embodiment, a flow chart 800 illustrates one embodiment of a manufacturing process supported by the described optical and mechanical components. In step 402, material is positioned in a cartridge, bed, chamber, or other suitable support. The material can be a metal plate for laser cutting using subtractive manufacture techniques, or a powder capable of being melted, fused, sintered, induced to change crystal structure, have stress patterns influenced, or otherwise chemically or physically modified by additive manufacturing techniques to form structures with desired properties.

In step 804, unpatterned laser energy is emitted by one or more energy emitters, including but not limited to solid state or semiconductor lasers, and then amplified by one or more laser amplifiers. In step 806, the unpatterned laser energy is shaped and modified (e.g. intensity modulated or focused). In step 808, this unpatterned laser energy is patterned, with energy not forming a part of the pattern being handled in step 810 (this can include conversion to waste heat, recycling as patterned or unpatterned energy, or waste heat generated by cooling the laser amplifiers in step 804). In step 812, the patterned energy, now forming a one or two-dimensional image is relayed toward the material. In step 814, the image is applied to the material, either subtractively processing or additively building a portion of a 3D structure. For additive manufacturing, these steps can be repeated (loop 818) until the image (or different and subsequent image) has been applied to all necessary regions of a top layer of the material. When application of energy to the top layer of the material is finished, a new layer can be applied (loop 816) to continue building the 3D structure. These process loops are continued until the 3D structure is complete, when remaining excess material can be removed or recycled.

A number of other embodiments pertaining to cartridge design, operation, and integration into an additive manufacturing system are contemplated. For example, a cartridge can be designed to allow electronic identification such as provided by an electronically readable memory or other electronically readable indicia such as attached text, QR codes, or bar codes. The memory can provide electronic information about the cartridge or cartridge components can be used to identify its make, model, type, powder type, or any other defining details about the unit, its sub-components, or their intended uses. This information can be used to inform a print engine about what material is to be printed, desired atmosphere (pressure and temperature), or other print related aspect so the print engine can adapt as needed to accommodate the print cartridge, or sub-assembly. The change induced could involve an action such as the automatic swapping of internal lens assemblies, adjustment of z-height/final optical throw of the lens assembly, laser parameter adjustment such as power per unit area, pulse shape, pulse duration, pulse repetition rate, wavelength, spatial pulse shape, tile size, spatial energy distribution within a tile, modify data diagnostics, data feedback algorithms, print process feedback algorithms, or algorithmic change to how tiles are put down during the print process. Electronic information from electronic memory that is associated with a print cartridge can be read by a printer, de-powdering station, or storage rack to collect data on how much printing has occurred and other key metrics such as number of spreader cycles, z-axis adjustments, temperature cycles, pressure cycles, or other attribute that the cartridge has undergone along the way. This information can also be stored in a central database by the print station, one of the subsystems, the factory automation system, de-powdering station, cartridge storage station, the cartridge itself, or other mating/interfacing equipment.

In some embodiments particularly suitable for additive manufacturing systems supporting large cartridges, a transporter could interface with the cartridge so that all or some of its services and functions are active, or a cartridge may be partially or fully disconnected from services and be non-functional while being carried by the transporter. In some instances, the transporter can be a human driven cartridge transporter, but in other embodiments, the transporter can be partially or wholly automated. In other instances, the partial or fully automated transporter can be guided by tele-presence cameras (remote operator), guided by embedded transponders, by simple or complex algorithms such as artificial intelligence, neural networks, deep learning networks, neuromorphic processing, or other automated decision methods and aided by any number of optical or non-optical sensors. Various types of transporters are contemplated. In some embodiments, rollers, telescoping tubes, pick and place robot, overhead lifting, rails, or conveyors can be used. Forklift tubes can be replaced with a cart, automated equipment like a conveyor belt, rails, robotic equipment like bottom lift stockers, robotic tug, or a robotic forklift. Use of an overhead gantry/crane mechanism; a (manual or fully automated) cart or buggy that rolls on the floor, arrive on a manual or automated railway system which could be wheeled or unwheeled (maglev, air bearing), robotic manipulator, conformal body power suit are alternative embodiments.

An additive manufacturing system can include a variety of potential components and stations. For example, an additive manufacturing system can include a print engine (composed of a print station and a laser engine), a storage (rack) station, a facility station, and a powder prep/de-powdering station. The powder prep station could be one station for prepping a cartridge which would include removing powder from a cartridge that already had undergone printing. These two functions (prepping a cartridge and powder removal) could be done in one station or two separate in which case the prepping station could be called ‘prep’ while the other could be called ‘de-powdering’. The other stations can include surface cladding station, heat treating station, CNC/machining station, surface finishing station, a prep service station, a de-burring station, a powder re-sieving station, a powder surface treatment/coating station, a LUIS diagnostic station, other volumetric and surface diagnostic station, and other processing station. The laser engine mates to and interacts with the print station (to form a print engine), the surface cladding station, the LUIS diagnostic station, and may interact with heat treating station and the surface finishing station.

The print station, the surface cladding station, the heat-treating station, the CNC/machining station, the surface finishing station, and the deburring station does post processing on the printed part. The surface cladding station in conjunction with the laser engine operates on the printed part to add a functional layer to selected surfaces as in the case of drill bits, airfoil surfaces, turbine blades or medical implants. The heat-treating station, in conjunction with the laser engine can perform surface annealing and hardening or it can do this form of post processing using other traditional methods such as standard thermal sources or directed energy non-laser sources. The CNC/machining station performs standard subtractive manufacturing on a printed part for final figure and form. The surface finishing station 49P can interact with the laser engine to perform surface smoothing via mass transport/surface tension, or laser peening/hardening. The surface finishing station can also be performed in more traditional subtractive methods as well. The deburring station would use traditional subtractive machining methods to enhance surface finish of the printed part. The LUIS diagnostic station would couple with the Laser Engine to volumetric scan the printed part to ensure print accuracy, density, and defect statistics. Additionally, LUIS and other volumetric diagnostics (can be used in conjunctions with a storage station and Laser Engine to determine functionality of the printed part under conditional environments such as high or low heat, high pressure or partial vacuum, or other environmental or operation extremes to ensure the printed part can withstand static operational performance requirements.

A prep service station can be used to service the cartridge and may be used in conjunction with the powder station and facility station. In the prep station, consumables (such as the blade, build plate, and HEPA filter) are replaced in a manner to minimize human interaction with the dirty environments. Gases and fluids are removed for post processing via the facility station. Used powder is removed and transferred to the powder re-sieving station for powder recovery.

The powder treatment/coating station treats the powder for chemistry or emissivity enhancements, this would depend on which powder/metal is being used but could include chemical or oxide treatment to enhance emissivity (such as increasing the absorption of copper or steel by surface treatment of the powder) of by adding chemical dopants to the powder for special print parameters.

Other volumetric diagnostics station would include x-ray tomography, surface scanning imaging, high resolution surface and thermography imaging to name a few in which the printed part is manipulated while minimizing handling damage and not exposing the human to dangerous metrology methods (as in the x-ray tomography case).

Another advantage of the described additive manufacturing system is that printer uptime is increased by reducing idle time between prints. When a print completes, operators can remove the print cartridge, immediately install a new cartridge and start a new print. The idle time between prints is reduced from hours to minutes. Print cartridges can be cleaned, serviced, and charged with fresh powder and new print plates off-line in the prep station. The work is done in a sealed environment so that the print chamber and powder are never exposed to air, high humidity, or factory contaminants. Fresh cartridges can be prepared in advance to meet a customer's production schedule. Fresh cartridges are placed in the storage rack where they can be pre-heated, chilled, pressurized, or de-pressurized in whatever gas atmosphere is required. When a space opens up on a printer, any fresh cartridge can be plugged in and the print starts immediately, as there is no wait time for it to be preheated or purged of atmospheric gases.

Another advantage of the described additive manufacturing system is that the cartridge and or stations can be slightly or highly modified to suit the requirements of customers. For example, a cartridge could be designed with print plate of much smaller surface area or of a different shape (i.e. round instead of square). This could for example allow a customer to print small volumes of very expensive materials (e.g. gold). This small volume cartridge could be designed to interface with various print stations to maximize the print material flexibility for the customer.

Another advantage of the described additive manufacturing system is that it allows thermal processing of prints (e.g. heat treating, annealing, controlled cool down) without removing the prints from the controlled environment in which they were printed (i.e. the print cartridge heats and cools and controls the atmosphere). Cartridges can be sent to the storage rack and kept at any temperature in any gas environment as dictated by the customer. The prints have not been exposed to atmospheric air or allowed to cool, so the customer has excellent control to affect the material properties. This may also mitigate problems with print plates warping due to thermal stress.

Another advantage of the described additive manufacturing system is that it allows creating prints in any of multiple print cartridges that can be installed simultaneously in one or more auxiliary print stations. This will further reduce overall print time by utilizing laser energy that would otherwise be wasted. It will also provide the customer with flexibility in scheduling prints and will also increase machine utilization.

Another advantage of the described additive manufacturing system is that the cartridge and features in mating equipment could be implemented as standard or optional features on additive manufacturing systems made by other equipment makers. The technology provided as subsystems to be incorporated into additive manufacturing equipment using laser powder bed fusion or other 3D printing methods. Any additive manufacturing system which utilizes the cartridge/stations scheme will enjoy the benefits of this scheme. Cartridges and stations could be slightly or highly modified to suit the particular needs of manufacturers or customers.

A storage rack can be made in many different sizes to carry one or many multiples of cartridges. Cartridges can be programmed at the storage rack and automatically set up for the job to be run based on pre-determined job-scheduling. Electronic memory held within each cartridge could interface with the robotic manipulation system, crane, railway, transportation apparatus or communicate with the transporter and/or its operator, or system to tell it which print station/engine to connect to in a production setting. A cartridge can be battery powered so sensor or information providing functionality is possible when dismounted.

The print engine could have more than one auxiliary print station attached to it (i.e. 1-N), N could be 1, 10, 100, or 1000, or somewhere in between, or more.

Print cartridges could be filled with the same or different materials while simultaneously or sequentially printing.

Laser light could be split among the print stations before patterning where each print station has its own light valve or patterning device. In other embodiments, laser light could be split among the chamber after patterning where the first chamber gets the positive (priority) image, and subsequent chambers get the leftover (negative) images.

The energy fluence directed to each cartridge could be the same or could change based on the material type.

In one embodiment use of print cartridges and/or print engine can be prioritized, with use of each print cartridge or engine able to be prioritized before or during the print. For example, a cartridge with priority can remain static or can change based on inputs (i.e. from the user such as a job priority change, or due to print completion, print error, or other outside desire). The priority of any cartridge can be promoted or demoted. For example, if there are two cartridges, and a top priority cartridge becomes idle (due to user intervention, sub-system process such as spreading, image loading, or the like, error, etc.) priority will then change to the previously lower priority cartridge so overall printing throughput is maximized. Variations of this are true for any number of cartridge greater than one. As another example, a customer could prioritize the printing of a high temperature print in a primary print station with inserted primary cartridge, and assign a lower priority to a room temperature, less demanding print in the auxiliary print station(s). The low temperature print can proceed at a much slower pace without sacrificing print quality, or needlessly keeping the auxiliary chamber hot.

Each print cartridge in each print station could be printing the same or different print files. Each print could be started and stopped while prints in auxiliary print cartridges continue to print. Print cartridges can be installed or removed from the print station during printing operations with more than one chamber without interrupting the print process in the non-removed chambers.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims. It is also understood that other embodiments of this invention may be practiced in the absence of an element/step not specifically disclosed herein.

1. A cartridge for an additive manufacturing system, comprising:
a sealable chamber having a bed;
a powder hopper positioned within the sealable chamber; and,
a powder spreader for distributing powder from the powder hopper onto the bed, wherein the powder spreader comprises a spreader assembly and a soot confinement enclosure.

2. The cartridge of claim 1, comprising a dosing mechanism arranged to deposit a specified amount of powder from the powder hopper onto the bed.

3. The cartridge of claim 1, comprising a dosing mechanism including:
a ram located within a first bore;
a second bore positioned at an inclined angle relative to the first bore, the second bore open to the powder hopper;
a cylindrical valve comprising a third bore and a fourth bore; wherein,
the cylindrical valve is rotatable such that the second and fourth bores align to feed powder to the ram; and,
the cylindrical valve is further rotatable such that the first and third bores align to enable the ram to push powder through the bores to the print bed.

4. The cartridge of claim 1 comprising an at least one partially detachable lid, the at least partially detachable lid comprising one or more laser transparent windows.

5. The cartridge of claim 4 wherein the partially detachable lid further comprises one or more drive mechanisms for the powder spreader.

6. The cartridge of claim 4 wherein the partially detachable lid further comprises one or more process monitoring windows.

7. The cartridge of claim 4 wherein the partially detachable lid further comprises one or more circuits for heating or cooling.

8. The cartridge of claim 4 wherein the partially detachable lid further comprises one or more sensors for monitoring one or more print processes.

9. The cartridge of claim 8 wherein the one or more print processes are selected from at least one of print monitoring, thermal monitoring, oxygen monitoring, pressure monitoring, moisture monitoring, powder level monitoring, and print station interface monitoring.

10. The cartridge of claim 4 wherein the partially detachable lid further comprises one or more connectors for connecting the cartridge to a print station.

11. The cartridge of claim 10 wherein the one or more connectors are selected from one or more connectors for power, water, control signals, and gear coupling for one or more drives.

12. The cartridge of claim 1 comprising one or more replaceable seals.

13. The cartridge of claim 1 wherein the spreader assembly is adjustable in at least one dimension.

14. The cartridge of claim 1 comprising one or more additional soot management mechanisms.

15. The cartridge of claim 14 wherein the additional soot management mechanism comprises a cross-bed airflow.

16. The cartridge of claim 15 wherein the cross-bed airflow is a multi-zone cross bed airflow.

17. A method for operating an additive manufacturing system,
providing a sealable chamber having a bed;
positioning a powder hopper within the sealable chamber; and,
distributing powder from the powder hopper onto the bed using a powder spreader, wherein the powder spreader comprises a spreader assembly and a soot confinement enclosure.

18. The cartridge of claim 17, comprising a dosing mechanism arranged to deposit a specified amount of powder from the powder hopper onto the bed.

19. An additive manufacturing system, comprising:
a cartridge comprising a sealable chamber having a bed;
a powder hopper positioned within the sealable chamber;
a powder spreader for distributing powder from the powder hopper onto the bed, wherein the powder spreader comprises a spreader assembly and a soot confinement enclosure; and
a dosing mechanism arranged to deposit a specified amount of powder from the powder hopper onto the bed.

20. The additive manufacturing system of claim 19, comprising a partially detachable lid attached to the sealable chamber and having one or more sensors for monitoring one or more print processes.
